(19) United States
(12) Patent Application Publication
(10) Pub. No.: US 2026/0048642 A1
(43) Pub. Date: Feb. 19, 2026

(54) Privacy Glass

(71) Applicant: Vitro Flat Glass LLC, Cheswich, PA (US)

(72) Inventors: Patrick Fisher, Pittsburgh, PA (US); Andrew V. Wagner, Pittsburgh, PA (US)

(21) Appl. No.: 19/290,534

(22) Filed: Aug. 5, 2025

Related U.S. Application Data
(60) Provisional application No. 63/683,385, filed on Aug. 15, 2024.

(51) Int. Cl. B60J 3/00; B32B 17/10

(52) U.S. Cl. CPC B60J 3/007; B32B 17/10036; B32B 17/10229; B32B 17/10449; B32B 17/10651; B32B 2307/41; B32B 2307/416; B32B 2307/7376; B32B 2605/00

(57) ABSTRACT

A privacy glass includes: a first transparency having a first major surface and an opposing second major surface, the No. 1 surface defining an exterior of the privacy glass; a second transparency having a third major surface and an opposing fourth major surface, the No. 4 surface defining an interior of the privacy glass; and an interlayer positioned between the No. 2 surface and the No. 3 surface. A solar control coating is arranged over the No. 2 surface, the solar control coating configured to reflect at least 50% of solar infrared radiation. At least one of the interlayer and the second transparency is tinted so that the privacy glass has a visible transmittance of less than 30%. The solar control coating is selected such that the privacy glass has an a* of from −4 to 0.5 and an b* of from −4 to 2.

### CROSS-REFERENCE TO RELATED APPLICATIONS

This application claims priority to U.S. Provisional Application No. 63/683,385 filed Aug. 15, 2024, the disclosure of which is hereby incorporated by reference in its entirety.

### BACKGROUND

### Field

The present disclosure is directed to a privacy glass, such as privacy glass used in vehicles. The present disclosure is also directed to a vehicle including the privacy glass.

### Technical Considerations

Privacy glass is glass that has a low visible transmittance (e.g., less than or equal to 30%). Privacy glass can be used in a variety of applications, such as automotive applications and architectural applications. There are generally no limitations regarding where privacy glass can be incorporated in a building. In some automotive applications, privacy glass can only be incorporated in the rear window, rear sidelights, and a moonroof or sunroof due to the regulations imposed in the United States and some other countries.

Privacy glass can be highly absorptive in certain regions of the electromagnetic spectrum, leading to increased temperature of the glass. Attempts to mitigate temperature increases in the privacy glass can negatively affect the aesthetics of the thereof.

### SUMMARY OF THE DISCLOSURE

According to some non-limiting aspects of the disclosure, a privacy glass includes: a first transparency having a first major surface (No. 1 surface) and an opposing second major surface (No. 2 surface), the No. 1 surface defining an exterior of the privacy glass; a second transparency having a third major surface (No. 3 surface) and an opposing fourth major surface (No. 4 surface), the No. 4 surface defining an interior of the privacy glass; and an interlayer positioned between the No. 2 surface and the No. 3 surface, where a solar control coating is arranged over the No. 2 surface, the solar control coating configured to reflect at least 50% of solar infrared radiation (ISO 9050:2003, 780-2500 nm), where at least one of the interlayer and the second transparency is tinted so that the privacy glass has a visible transmittance of less than 30%, where the solar control coating is selected such that the privacy glass has an a* of from −4 to 0.5 and an b* of from −4 to 2.

### BRIEF DESCRIPTION OF THE DRAWINGS

The invention will be described with reference to the following drawing figures wherein like reference numbers, identify like parts throughout.

FIGS. 1-3 are cross-sectional views (not to scale) of privacy glass, according to some aspects of the disclosure;

FIGS. 4-6 are cross-sectional views (not to scale) of solar control coatings, according to some aspects of the disclosure; and

FIG. 7 is an illustration of a vehicle including privacy glass, according to some aspects of the disclosure.

### DETAILED DESCRIPTION

As used herein, spatial or directional terms, such as “left”, “right”, “inner”, “outer”, “above”, “below”, and the like, relate to the invention as it is shown in the drawing figures. However, it is to be understood that the invention can assume various alternative orientations and, accordingly, such terms are not to be considered as limiting. Further, as used herein, all numbers expressing dimensions, physical characteristics, processing parameters, quantities of ingredients, reaction conditions, and the like, used in the specification and claims are to be understood as being modified in all instances by the term “about.” Accordingly, unless indicated to the contrary, the numerical values set forth in the following specification and claims may vary depending upon the desired properties sought to be obtained by the present invention. At the very least, and not as an attempt to limit the application of the doctrine of equivalents to the scope of the claims, each numerical value should at least be construed in the light of the number of reported significant digits and by applying ordinary rounding techniques. Moreover, all ranges disclosed herein are to be understood to encompass the beginning and ending range values and any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more and ending with a maximum value of 10 or less, e.g. 1 to 3.3, 4.7 to 7.5, 5.5 to 10, and the like. “A” or “an” refers to one or more.

Further, as used herein, the terms “formed over”, “deposited over”, or “provided over” mean formed, deposited, or provided on but not necessarily in contact with the surface. For example, a coating layer “formed over” a substrate does not preclude the presence of one or more other coating layers or films of the same or different composition located between the formed coating layer and the substrate.

As used herein, the terms “polymer” or “polymeric” include oligomers, homopolymers, copolymers, and terpolymers, e.g., polymers formed from two or more types of monomers or polymers.

The terms “visible region” or “visible light” refer to electromagnetic radiation having a wavelength in the range of 380 nanometers (nm) to 800 nm. The terms “infrared region” or “infrared radiation” refer to electromagnetic radiation having a wavelength in the range of greater than 800 nm to 100,000 nm. The terms “ultraviolet region” or “ultraviolet radiation” mean electromagnetic energy having a wavelength in the range of 300 nm to less than 380 nm. Visible (luminous) transmittance (LTA) values (Y, x, y) herein are those determinable using C.I.E. (1976) standard illuminant “A” with a 2-degree observer (in conformance with U.S. Federal standards) over the wavelength range of 380 nm to 770 nm using a spectrophotometer. Glass-side (e.g., exterior) reflected color values L*, a*, b* are in accordance with the 1976CIELAB color system specified by the International Commission on Illumination. The L*, a*, b* values and ranges reported herein may be measured at an 8° angle. However, the L*, a*, b* ranges recited herein may be satisfied by the privacy glass at a plurality of angles in the range of 0° to 85°, such as at all angles in the range of 0° to 85° or all angles in the range of 0° to 10°.

As used herein, the term “film” refers to a coating region of a desired or selected coating composition. A “layer” can comprise one or more “films”, and a “coating” or “coating stack” can comprise one or more “layers”.

The terms “metal” and “metal oxide” include silicon and silica, respectively, as well as traditionally recognized metals and metal oxides, even though silicon conventionally may not be considered a metal. Thickness values, unless indicated to the contrary, are geometric thickness values. Additionally, all documents, such as, but not limited to issued patents and patent applications, referred to herein, are to be considered “incorporated by reference” in their entirety.

The discussion of the invention may describe certain features as being “particularly” or “preferably” within certain limitations (e.g. “preferably”, “more preferably”, or “most preferably”, within certain limitations). It is to be understood that the invention is not limited to these particular or preferred limitations but encompasses the entire scope of the disclosure.

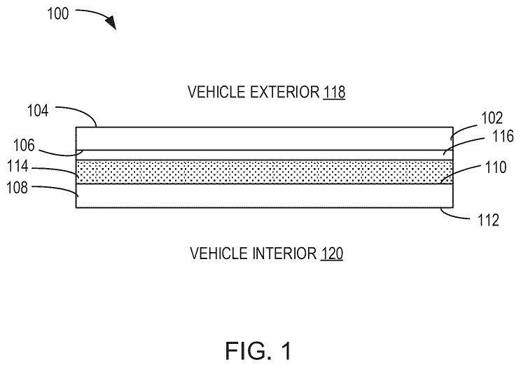

Referring to FIGS. 1-3 cross-sectional views (not to scale) of privacy glass 100 are shown according to some non-limiting embodiments or aspects. The privacy glass 100 may comprise a first transparency 102 having a first major surface (No. 1 surface 104) and an opposing second major surface (No. 2 surface 106). The No. 1 surface 104 may define an exterior of the privacy glass 100. The privacy glass 100 may comprise a second transparency 108 having a third major surface (No. 3 surface 110) and an opposing fourth major surface (No. 4 surface 112). The No. 4 surface 112 may define an interior of the privacy glass 100. The privacy glass 100 may comprise a solar control coating 116 arranged over the No. 2 surface 106, the solar control coating 116 configured to reflect at least 50% of solar infrared radiation (ISO 9050:2003, 780-2500 nm). The privacy glass 100 may comprise an interlayer 114 positioned between the No. 2 surface 106 and the No. 3 surface 110. At least one of the interlayer 114 and the second transparency 108 may be tinted so that the privacy glass 100 has a visible transmittance of less than 30%. The solar control coating 116 may be selected such that the privacy glass 100 has an a* of from −4 to 0.5 and an b* of from −4 to 2. The solar control coating 116 may be selected such that the privacy glass 100 has an a* of from −4 to 0.5 and an b* of from −4 to 2 at a plurality of angles from 0° to 85°, such as at all angles from 0° to 85° or all angles in the range of 0° to 10°.

With continued reference to FIGS. 1-3, the privacy glass 100 may comprise the first transparency 102 and the second transparency 108. The first transparency 102 and the second transparency 108 may be bonded together via the interlayer 114. The No. 1 surface 104 of the first transparency 102 may define an exterior of the privacy glass 100, and the No. 4 surface 112 of the second transparency 108 may define an interior of the privacy glass 100. When used in vehicle applications, the No. 1 surface 104 may be adjacent to the vehicle exterior 118, while the No. 4 surface 112 may be adjacent to the vehicle interior 120. When used in architectural applications, the No. 1 surface 104 may be adjacent to the building exterior, while the No. 4 surface 112 may be adjacent to the building interior.

The first transparency 102 and the second transparency 108 may be formed from the same or different materials. Examples of suitable materials include, but are not limited to, plastic substrates (such as acrylic polymers, such as polyacrylates; polyalkylmethacrylates, such as polymethylmethacrylates, polyethylmethacrylates, polypropylmethacrylates, and the like; polyurethanes; polycarbonates; polyalkylterephthalates, such as polyethyleneterephthalate (PET), polypropyleneterephthalates, polybutyleneterephthalate, and the like; polysiloxane-containing polymers; or copolymers of any monomers for preparing these, or any mixtures thereof); ceramic substrates; glass substrates; or mixtures or combinations of any of the above.

For example, the first transparency 102 and/or the second transparency 108 may include conventional soda-lime-silicate glass, borosilicate glass, or leaded glass. The glass can be clear glass. By “clear glass” is meant non-tinted or non-colored glass. Alternatively, the glass can be tinted or otherwise colored glass. The glass can be annealed or heat-treated glass. As used herein, the term “heat-treated” means tempered or at least partially tempered. The glass can be of any type, such as conventional float glass, and can be of any composition having any optical properties, e.g., any value of visible transmission, ultraviolet transmission, infrared transmission, and/or total solar energy transmission. By “float glass” is meant glass formed by a conventional float process in which molten glass is deposited onto a molten metal bath and controllably cooled to form a float glass ribbon. The ribbon is then cut and/or shaped and/or heat treated as desired. Examples of float glass processes are disclosed in U.S. Pat. Nos. 4,466,562 and 4,671,155. The first transparency 102 and the second transparency 108 may be, for example, clear float glass or can be tinted or colored glass or one of the first transparency 102 and the second transparency 108 can be clear glass and the other of the first transparency 102 and the second transparency 108 may be colored glass. Although not limiting to the invention, examples of glass suitable for the first transparency 102 and/or the second transparency 108 are described in U.S. Pat. Nos. 4,746,347; 4,792,536; 5,030,593; 5,030,594; 5,240,886; 5,385,872; and 5,393,593.

For example, one or more of the first transparency 102 and the second transparency 108 may be transparent or translucent to visible light. By “transparent” is meant having visible light transmittance of greater than 50% to 100%, such as greater than 70% to 100%. Alternatively, one or more of the first transparency 102 and the second transparency 108 may be translucent. By “translucent” is meant allowing electromagnetic energy (e.g., visible light) to pass through but diffusing this energy such that objects on the side opposite the viewer are not clearly visible. By “opaque” is meant having a visible light transmittance of 0%.

The first transparency 102 and the second transparency 108 may be of any desired dimensions, e.g., length, width, shape, or thickness. In one non-limiting example of the privacy glass 100, the first transparency 102 and the second transparency 108 may each be 1 mm to 10 mm thick, such as 1 mm to 5 mm thick, 1.5 mm to 2.5 mm, or 1.8 mm to 2.3 mm.

The first transparency 102 may be a clear or ultra-clear transparency (having a visible transmission of greater than 70% or greater than 80%). The first transparency 102 may comprise an ultra clear glass that is highly transparent in the visible region. The ultra clear glass may comprise glass having a total iron (Fe₂O₃) in the range of greater than 0.00 to 0.10 wt. % or less than 0.02 wt. %.

With continued reference to FIGS. 1-3, the privacy glass 100 may comprise the interlayer 114 positioned between the No. 2 surface 106 of the first transparency 102 and the No. 3 surface 110 of the second transparency 108.

The interlayer 114 may be of any desired material and can include one or more layers or plies. The interlayer 114 may be a polymeric or plastic material, such as, for example, polyvinyl butyral (“PVB”), plasticized polyvinyl chloride, or multi-layered thermoplastic materials including polyethyleneterephthalate, etc. Suitable interlayer materials are disclosed, for example but not to be considered as limiting, in U.S. Pat. Nos. 4,287,107 and 3,762,988. The interlayer 114 may also be a sound absorbing or attenuating material as described, for example, in U.S. Pat. No. 5,796,055. The interlayer 114 may be of any suitable thickness to hold the first transparency 102 and the second transparency 108 together. In one non-limiting embodiment, the interlayer 114 is a 0.76 millimeter (mm) thick layer of PVB.

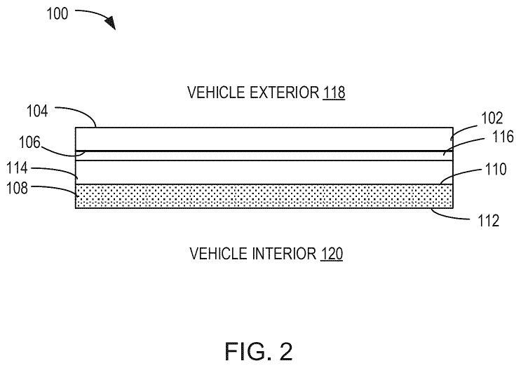

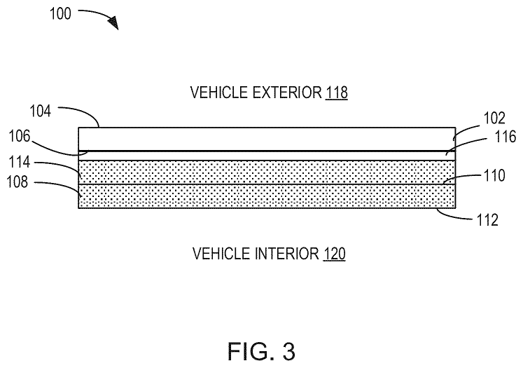

With continued reference to FIGS. 1-3, at least one of the interlayer 114 and the second transparency 108 may be tinted. As shown in FIG. 1, the interlayer 114 may be tinted. As shown in FIG. 2, the second transparency 108 may be tinted. As shown in FIG. 3, both the interlayer 114 and the second transparency 108 may be tinted. As used herein, “tinted” refers to a material having an LTA of less than 30.

The interlayer 114 and/or the second transparency 108 may be tinted in any suitable manner. For example, the interlayer 114 and/or the second transparency 108 may be tinted using an absorbing material configured to increase visible absorbance of the interlayer 114 and/or the second transparency 108 compared to the same interlayer and/or second transparency without the additive. The absorbing material may be contained in a coating applied to the interlayer 114 and/or the second transparency 108. Alternatively, the absorbing material may be contained within the interlayer 114 and/or the second transparency 108.

The interlayer 114 and/or the second transparency 108 is tinted so that it a visible transmittance of less than 30%, such as less than 20%, less than 15%, less than 10%, or less than 5%. The low visible transmittance of the multi-transparency glass product may make it “privacy” glass 100.

With continued reference to FIGS. 1-3 the solar control coating 116 may be arranged over the No. 2 surface 116. The solar control coating 116 may be arranged closer to the exterior compared to the tinted portion of the privacy glass 100 (e.g., at least one of the interlayer 114 and the second transparency 108). Arranging the solar control coating 116 closer to the exterior compared to the tinted portion of the privacy glass 100 may enable the privacy glass 100 to reflect away at least a portion of electromagnetic radiation (e.g., infrared radiation) before it can be absorbed by the tinted portion of the privacy glass 100.

The solar control coating 116 may be configured to reflect at least 50% of solar infrared radiation (ISO 9050:2003, 780-2500 nm).

The solar control coating 116 may be selected (e.g., designed by selecting layers, thicknesses of layers, arrangement of layers, and the like) such that the privacy glass 100 has an a* of from −4 to 0.5, such as from −2 to 0. The solar control coating 116 may be selected such that the privacy glass 100 has a negative a* value.

The solar control coating 116 may be selected (e.g., designed by selecting layers, thicknesses of layers, arrangement of layers, and the like) such that the privacy glass 100 has an b* of from −4 to 2, such as from −2 to 0. The solar control coating 116 may be selected such that the privacy glass 100 has a negative b* value.

This combination of neutral a* and b* values is such that the color of the privacy glass 100 is aesthetically neutral. Further, the combination of neutral a* and b* values is such that the privacy glass 100 appears visually identical in regions of the privacy glass 100 not containing the solar control coating 116 compared to regions of the privacy glass 100 containing the solar control coating 116. It will be appreciated that certain regions of the privacy glass 100 may remain uncoated by the solar control coating 116. Such regions may not contain the solar control coating 116 as they may be intended to have radiation within predetermined regions transmitted therethrough, such that the solar control coating 116 would undesirably affect the transmission. For example, radiation may be emitted through certain regions of the privacy glass 100 from a radiation source or may be detected by a radiation detector, such as in autonomous vehicle applications.

The solar control coating 116 may be selected (e.g., designed by selecting layers, thicknesses of layers, arrangement of layers, and the like) such that the privacy glass 100 has a glass-side L* of up to 50, such as up to 40, or up to 35. The glass-side L* may range from 15-50, such as from 20-50, from 20-40, from 20-35, from 20-30, or from 25-30. The selection of L* within these ranges may imitate an uncoated glass aesthetic.

These glass-side L*, a*, b* values and ranges reported herein may be satisfied at an 8° angle. The L*, a*, b* ranges recited herein may be satisfied by the privacy glass at a plurality of angles in the range of 0° to 85°, such as at all angles in the range of 0° to 85° or all angles in the range of 0° to 10°.

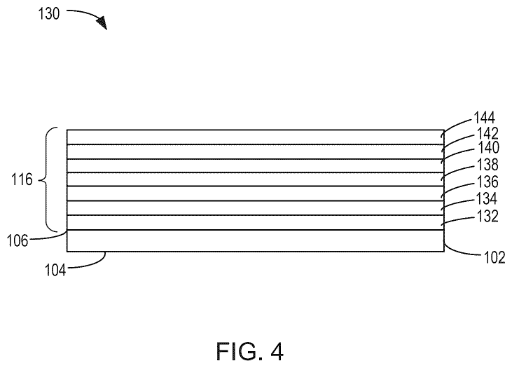

Referring to FIGS. 4-6, cross-sectional views (not to scale) are shown of coated transparencies 130 containing solar control coatings 116 according to some aspects of the disclosure. The coated transparency 130 may comprise the first transparency 102 having the No. 1 surface 104 and the No. 2 surface 106 with the solar control coating 116 arranged over the No. 2 surface 106. The solar control coating 116 may be arranged closer to an exterior of the privacy glass 100 (see e.g., FIGS. 1-3) compared to the tinted components of the privacy glass 100 (e.g., the interlayer 114 and/or the second transparency 108). The solar control coating 116 may be arranged closer to an exterior of the privacy glass 100 compared to the tinted components of the privacy glass 100 to enable the solar control coating 116 to reflect at least a portion of the radiation (e.g., at least a portion of the infrared radiation) before said radiation reaches the tinted components, where it may be absorbed and lead to further temperature increase of the privacy glass 100.

The solar control coating 116 may be configured to block (e.g., by reflection and/or fluorescence) at least a portion of the solar radiation incident to the privacy glass 100, so as to regulate the temperature thereof and/or the temperature of the environment enclosed by the privacy glass 100, such as the interior of a vehicle or building. As used herein, the term “solar control coating” refers to a coating comprised of one or more layers or films that affect the solar properties of the coated glass substrate, such as, but not limited to, the amount of solar radiation, for example, visible, infrared, or ultraviolet radiation, reflected from, absorbed by, or passing through the coated article; shading coefficient; emissivity, etc. The solar control coating can block, absorb, or filter selected portions of the solar spectrum, such as, but not limited to, the IR, UV, and/or visible spectrums, or portions thereof. Non-limiting examples of solar control coatings are described, for example, in U.S. Pat. Nos. 10,345,499; 10,358,384; 10,539,726; 10,703,673; 11,078,718; 11,267,752; 11,402,557.

FIGS. 4-6 provide non-limiting examples of solar control coatings 116 suitable for use in the present disclosure.

Referring to FIG. 4, the solar control coating 116 may be arranged over at least a portion of the No. 2 surface 106 of the first transparency 102. The solar control coating 116 may comprise a first dielectric layer 132 over at least a portion of the No. 2 surface 106. The first dielectric layer 132 may be in direct contact with the No. 2 surface 106 and/or one or more intervening layers may be arranged between the first dielectric layer 132 and the No. 2 surface 106.

The solar control coating 116 may comprise a first metallic layer 134 over at least a portion of the first dielectric layer 132. The first metallic layer 134 may be in direct contact with the first dielectric layer 132 and/or one or more intervening layers may be arranged between the first metallic layer 134 and the first dielectric layer 132.

The solar control coating 116 may comprise a second dielectric layer 136 over at least a portion of the first metallic layer 134. The second dielectric layer 136 may be in direct contact with the first metallic layer 134 and/or one or more intervening layers may be arranged between the second dielectric layer 136 and the first metallic layer 134.

The solar control coating 116 may comprise a second metallic layer 138 over at least a portion of the second dielectric layer 136. The second metallic layer 138 may be in direct contact with the second dielectric layer 136 and/or one or more intervening layers may be arranged between the second metallic layer 138 and the second dielectric layer 136.

The solar control coating 116 may comprise a third dielectric layer 140 over at least a portion of the second metallic layer 138. The third dielectric layer 140 may be in direct contact with the second metallic layer 138 and/or one or more intervening layers may be arranged between the third dielectric layer 140 and the second metallic layer 138.

The solar control coating 116 may comprise a third metallic layer 142 over at least a portion of the third dielectric layer 140. The third metallic layer 142 may be in direct contact with the third dielectric layer 140 and/or one or more intervening layers may be arranged between the third metallic layer 142 and the third dielectric layer 140.

The solar control coating 116 may comprise a fourth dielectric layer 144 over at least a portion of the third metallic layer 142. The fourth dielectric layer 144 may be in direct contact with the third metallic layer 142 and/or one or more intervening layers may be arranged between the fourth dielectric layer 144 and the third metallic layer 142.

FIG. 4 shows a non-limiting arrangement in which the first dielectric layer 132 is in direct contact with the No. 2 surface 106, the first metallic layer 134 is in direct contact with the first dielectric layer 132; the second dielectric layer 136 is in direct contact with the first metallic layer 134; the second metallic layer 138 is in direct contact with the second dielectric layer 136; the third dielectric layer 140 is in direct contact with the second metallic layer 138; the third metallic layer 142 is in direct contact with the third dielectric layer 140; and the fourth dielectric layer 144 is in direct contact with the third metallic layer 142.

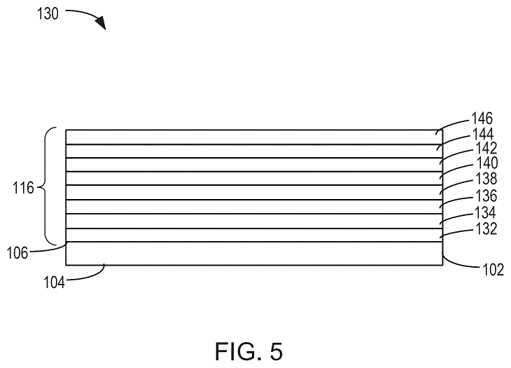

Referring to FIG. 5, the solar control coating 116 illustrated therein is similar to the solar control coating 116 illustrated in FIG. 4 except as described hereinafter. The solar control coating 116 may further comprise an outermost protective layer 146 over the outermost dielectric layer (e.g., fourth dielectric layer 144). The outermost protective layer 146 may be in direct contact with the outermost dielectric layer and/or one or more intervening layers may be arranged between the outermost dielectric layer and the outermost protective layer 146. As shown in FIG. 5, the outermost protective layer 146 may be in direct contact with the fourth dielectric layer 144.

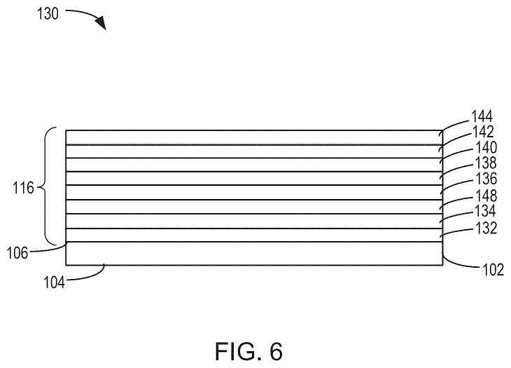

Referring to FIG. 6, the solar control coating 116 illustrated therein is similar to the solar control coating 116 illustrated in FIG. 4 except as described hereinafter. The solar control coating 116 may further comprise at least one primer layer 148 over at least one of the metallic layers. The primer layer 148 may be in direct contact with the metallic layer over which it is arranged and/or one or more intervening layers may be arranged between the metallic and the primer layer 148.

The non-limiting embodiment of FIG. 6 shows a primer layer 148 arranged directly over the first metallic layer 134, although it will be appreciated that a primer layer 148 may additionally or alternatively be arranged directly over the second metallic layer 138 and/or the third metallic layer 142. In some non-limiting embodiments or aspects, a primer layer 148 may be arranged over (e.g., directly over) each metallic layer of the solar control coating 116.

The non-limiting embodiments shown in FIG. 4-6 include three metallic layers (e.g., “triple silver” coatings), but it will be appreciated that other number of metallic layers may be used, such as one (e.g., “single silver” coatings), two (e.g., “double silver” coatings), four (e.g., “quadruple silver” coatings), and the like.

The solar control coating 116 may be deposited directly over the glass substrate or another coating layer by any suitable method, such as, but not limited to, chemical vapor deposition (CVD) and/or physical vapor deposition (PVD) methods. Examples of CVD processes include spray pyrolysis. Examples of PVD processes include electron beam evaporation and vacuum sputtering (such as magnetron sputter vapor deposition (MSVD)). Other coating methods could also be used, such as, but not limited to, sol-gel deposition. In one non-limiting embodiment, a coating layer is deposited by MSVD. Examples of MSVD coating devices and methods will be well understood by one of ordinary skill in the art and are described, for example, in U.S. Pat. Nos. 4,379,040; 4,861,669; 4,898,789; 4,898,790; 4,900,633; 4,920,006; 4,938,857; 5,328,768; and 5,492,750.

In the MSVD method, an oxide of a metal or metal alloy can be deposited by sputtering a metal or metal alloy containing cathode in an oxygen containing atmosphere to deposit a metal oxide or metal alloy oxide film on the surface of the substrate. In one embodiment, the solar control coating 116 may be deposited over all or substantially all of the surface, i.e., is not deposited to form discrete coated areas. The solar control coating 116 may be deposited over a flat substrate and then the substrate can be bent of shaped in any conventional manner, such as by heating. Alternatively, the solar control coating 116 may be deposited over a curved surface, i.e., a substrate that has already been bent or shaped.

With continued reference to FIGS. 4-6, the dielectric layers (e.g., the first, second, third, and fourth dielectric layers 132, 136, 140, 144) of the solar control coating 116 may be made from any suitable dielectric materials. Non-limiting examples of suitable dielectric materials include one or more films of antireflective materials and/or dielectric materials, such as, but not limited to metal oxides, oxides of metal alloys, nitrides, oxynitrides, or mixtures thereof. Examples of suitable metal oxides for the dielectric layers include oxides of titanium, niobium, zinc, indium, tin, magnesium, gallium, vanadium, aluminum, silicon, alloys thereof, mixtures thereof, and combinations thereof. These metal oxides can have small amount of other materials, such as manganese in bismuth oxide, tin in indium oxide, etc. Alternatively, oxides or metal alloys or metal mixtures, such as oxides containing zinc and tin (e.g., zinc stannate); oxides of indium-tin alloys; silicon nitrides; silicon aluminum nitrides; or aluminum nitrides can be used. Further, metal doped metal oxides, such as aluminum-doped zinc oxide, antimony-doped tin oxide, nickel- or boron-doped silicon oxides, gallium-doped zinc oxide, indium-doped zinc oxide, magnesium-doped zinc oxide, vanadium-doped zinc oxide, indium-doped tin oxides, or mixtures thereof can be used.

In some non-limiting embodiments, a dielectric layer of the solar control coating 116 may include a zinc/tin alloy oxide. The zinc/tin alloy oxide can be obtained from MSVD from a cathode of zinc and tin that can comprise zinc and tin in proportions of 10 wt. % to 90 wt. % zinc and 90 wt. % to 10 wt. % tin. One suitable metal alloy oxide that can be present is zinc stannate. By “zinc stannate” is meant a composition of ZnₓSn₁₋ₓO₂₋ₓ (Formula 1) where “x” varies in the range of greater than 0 to less than 1. For instance, “x” can be greater than 0 and can be any fraction or decimal between greater than 0 to less than 1. For example, where x=2/3, Formula 1 is Zn_{2/3}Sn_{1/3}O_{4/3}, which is more commonly described at Zn₂SnO₄. A zinc stannate containing film may have one or more of the forms of Formula 1 in a predominant amount in the film.

In some non-limiting embodiments, a dielectric layer of the solar control coating 116 may include a zinc-containing film, such as zinc oxide. The zinc oxide film may be deposited from a zinc cathode that includes other materials to improve the sputtering characteristics of the cathode. For example, the zinc cathode can include a small amount (e.g., less than 10 wt. %, such as greater than 0 to 5 wt. %) of tin to improve sputtering. In which case, the resultant zinc oxide film would include a small percentage of tin oxide, e.g., 0 to less than 10 wt. % tin oxide, e.g., 0 to 5 wt. % tin oxide. An oxide layer sputtered from a zinc/tin cathode having 95 wt. % zinc and 5 wt. % tin, or preferably 90 wt. % zinc and 10 wt. % tin, is referred to as a zinc oxide film. The small amount of tin in the cathode (e.g., less than 10 wt. %) is believed to form a small amount of tin oxide in the predominately zinc oxide-containing film.

In some non-limiting embodiments, a dielectric layer of the solar control coating 116 may include a film consisting of at least one of the following: aluminum-doped zinc oxide, gallium doped-zinc oxide, indium-doped zinc oxide, magnesium-doped zinc oxide, vanadium-doped zinc oxide, or indium-doped tin oxide. The aluminum-doped zinc oxide, gallium doped-zinc oxide, indium-doped zinc oxide, magnesium-doped zinc oxide, vanadium-doped zinc oxide, or indium-doped tin oxide film is deposited from a zinc cathode that includes other materials to improve the sputtering characteristics of the cathode. For example, the aluminum-doped zinc oxide, gallium doped-zinc oxide, indium-doped zinc oxide, magnesium-doped zinc oxide, vanadium-doped zinc oxide, or indium-doped tin oxide film can include a small amount (e.g., less than 10 wt. %, such as greater than 0 to 5 wt. %) of tin to improve sputtering. In which case, the resultant aluminum-doped zinc oxide, gallium doped-zinc oxide, indium-doped zinc oxide, magnesium-doped zinc oxide, vanadium-doped zinc oxide, or indium-doped tin oxide film would include a small percentage of tin oxide, e.g., 0 wt. % to less than 10 wt. % tin oxide, e.g., 0 wt. % to 5 wt. % tin oxide.

With continued reference to FIGS. 4-6, the metallic layers (e.g., the first, second, and third metallic layers 134, 138, 142) of the solar control coating 116 may be made from any suitable metallic materials. Non-limiting examples of suitable metallic materials include a reflective metal, e.g., a noble metal such as silver or gold, or combinations of alloys thereof. The metallic layers may comprise at least one of silver or gold. The metallic layers may comprise silver. The metallic layers can be continuous layers. By “continuous layer” is meant that the coating forms a continuous film of the material and not isolated coating regions.

With continued reference to FIGS. 4-6, the primer layers (e.g., the primer layer 148) of the solar control coating 116 may be made from any suitable primer materials. Non-limiting examples of suitable primer materials include zinc, aluminum, vanadium, tungsten, tantalum, niobium, zirconium, manganese, chromium, tin, nickel, germanium, magnesium, molybdenum, silver, silicon carbon, aluminum-doped silver, aluminum zinc, vanadium zinc, tungsten tantalum, titanium niobium, zirconium niobium, tungsten niobium, aluminum niobium, aluminum titanium, tungsten titanium, tantalum titanium, zinc titanium, aluminum silver, zinc tin, indium zinc, silver zinc, mixtures thereof, combinations thereof, or any alloys thereof.

The primer layer 148 may also take the form of a metal, oxide, sub-oxide, nitride, and/or sub-nitride of any of the above list of materials. At least a portion of the primer layer 148 may be an oxide or a nitride. In certain non-limiting embodiments, the primer layer 148 may be deposited in a 100% argon environment. In certain embodiments, a portion of the primer layer may be a nitride formed by sputtering the metal or metal alloy in a nitrogen (N₂) atmosphere that has a specific flow rate as to form an atmosphere of 80% N₂, with the remainder argon. The flow rate may be an approximation to the amount of nitrogen (N₂) in the atmosphere, but that one of ordinary skill in the art would recognize that additional N₂ may leak into the coating chamber as the coating chamber is not hermetically sealed from the outside environment.

In certain embodiments, a portion of the primer layer 148 may be a sub-oxide formed by sputtering the metal or metal alloy in an oxygen (O₂) atmosphere that has a specific flow rate as to form an atmosphere of 3% to 7% O₂, with the remainder argon. The flow rate may be an approximation to the amount of oxygen (O₂) in the atmosphere, but that one of ordinary skill in the art would recognize that additional O₂ may leak into the coating chamber as the coating chamber is not hermetically sealed from the outside environment. The chemical structure of the primer material is designated by weight percent (wt. %) of an element, x. For certain compositions, the lower limit of one of the materials in the composition may be “greater than 0”. When the lower limit is “greater than 0”, the weight percent of the material is not equal to zero but may be any wt. % greater than 0 and up to the wt. % of the upper limit. The composition can change before or after the layer is heated, due to reactions with atmospheric species. These reactions can change the wt. % distributed between the materials of the composition.

With continued reference to FIGS. 4-6, the protective layers (e.g., the protective layer 146) of the solar control coating 116 may be made from any suitable protective materials to assist in protecting the underlying layers, such as the metallic layers, from mechanical and chemical attack during processing. Non-limiting examples of suitable protective layers 146 include an oxygen barrier coating layer to prevent or reduce the passage of ambient oxygen into the underlying layers of the coating, such as during heating or bending.

The protective layer 146 may be of any desired material or mixture of materials and can be comprised of one or more protective films. In some non-limiting embodiments, the protective layer 146 can include a single layer comprising one or more metal oxide materials, such as but not limited to oxides of aluminum, silicon, or mixtures thereof. For example, the protective coating can be a single coating layer comprising in the range of 0 wt. % to 100 wt. % alumina and/or 100 wt. % to 0 wt. % silica, such as 5 wt. % to 95 wt. % alumina and 95 wt. % to 5 wt. % silica, such as 10 wt. % to 90 wt. % alumina and 90 wt. % to 10 wt. % silica, such as 15 wt. % to 90 wt. % alumina and 85 wt. % to 10 wt. % silica, such as 50 wt. % to 75 wt. % alumina and 50 wt. % to 25 wt. % silica, such as 50 wt. % to 70 wt. % alumina and 50 wt. % to 30 wt. % silica, such as 35 wt. % to 100 wt. % alumina and 65 wt. % to 0 wt. % silica, such as 70 wt. % to 90 wt. % alumina and 30 wt. % to 10 wt. % silica, e.g., 75 wt. % to 85 wt. % alumina and 25 wt. % to 15 wt. % silica, e.g., 88 wt. % alumina and 12 wt. % silica, e.g., 65 wt. % to 75 wt. % alumina and 35 wt. % to 25 wt. % silica, e.g., 70 wt. % alumina and 30 wt. % silica, e.g., 60 wt. % to less than 75 wt. % alumina and greater than 25 wt. % to 40 wt. % silica. Other materials, such as aluminum, chromium, hafnium, yttrium, nickel, boron, phosphorous, titanium, zirconium, and/or oxides thereof can also be present, such as to adjust the refractive index of the protective layer 146. In some non-limiting embodiments, the refractive index of the protective layer 146 can be in the range of 1 to 3, such as 1 to 2, such as 1.4 to 2, such as 1.4 to 1.8.

In some non-limiting embodiments, the protective layer 146 may be a combination silica and alumina coating. The protective layer 146 may be sputtered from two cathodes (e.g., one silicon and one aluminum) or from a single cathode containing both silicon and aluminum. This silicon aluminum oxide protective layer 146 can be written as SiₓAl₁₋ₓO_{(1.5+x)/2}, where x can vary from greater than 0 to less than 1. In some exemplary embodiments, the protective layer 146 may comprise 15 wt. % alumina and 85 wt. % silica. In some exemplary embodiments, the protective layer 146 may comprise SiO₂, Al₂O₃, SiAlO, alloys thereof, and mixtures thereof.

In some non-limiting embodiments, the protective layer 146 may be comprised of silicon nitride (Si₃N₄), silicon oxynitride (SiON), silicon aluminum nitride (SiAIN), silicon aluminum oxynitride (SiAlON), a mixture thereof, and/or an alloy thereof and which may provide increased durability to the coated article. The protective layer 146 may be formed of silicon nitride deposited with other materials having superior electrical conductivity to improve sputtering of the silicon. For example, during deposition, the silicon cathode may include a small amount (e.g., up to 20 wt. %, up to 15 wt. %, up to 10 wt. %, or up to 5 wt. %) of aluminum to improve sputtering. In such case, the resultant silicon nitride layer may include a small percentage of aluminum, e.g., up to 15 wt. % aluminum, e.g., up to 10 wt. % aluminum, e.g., up to 5 wt. % aluminum. A coating layer deposited from a silicon cathode having up to 10 wt. % aluminum (added to enhance the conductivity of the cathode) is referred to herein as a “silicon nitride” layer, even though a small amount of aluminum may be present. The small amount of aluminum in the cathode (e.g., less than or equal to 15 wt. %, such as less than or equal to 10 wt. %, such as less than or equal to 5 wt. %) is believed to form aluminum nitride in the predominately silicon nitride protective layer 146. The protective layer 146 may be formed in a nitrogen atmosphere; however, it is to be understood that other gasses, such as oxygen, may be present in the atmosphere during the deposition of the protective layer 146.

In some non-limiting embodiments, the protective layer 146 may be a multilayer coating comprising a first protective film and a second protective film formed over at least a portion of the first protective film (e.g., in direct contact therewith). The first protective film can comprise alumina, silica, titania, zirconia, tin oxide, alloys thereof, mixtures thereof, or combinations thereof. In one specific non-limiting embodiment, the first protective film can comprise alumina or alloy comprising alumina and silica. For example, the first protective film can comprise a silica/alumina mixture having greater than 5 wt. % alumina, such as greater than 10 wt. % alumina, such as greater than 15 wt. % alumina, such as 50 wt. % to 70 wt. % alumina, such as in the range of 60 wt. % to 100 wt. % alumina and 40 wt. % to 0 wt. % silica, e.g., 60 wt. % alumina and 40 wt. % silica. In another example, the first protective film can comprise zinc stannate. In another example, the first protective film can comprise zirconia.

The second protective film may comprise, for example, a metal oxide or metal nitride. The second protective film may be titania, alumina, silica, zirconia, tin oxide, a mixture thereof, or an alloy thereof. For example, the second protective film may comprise a titania/alumina mixture having 40 wt. % to 60 wt. % alumina and 60 wt. % to 40 wt. % titania; 45 wt. % to 55 wt. % alumina and 55 wt. % to 45 wt. % titania; 48 wt. % to 52 wt. % alumina and 52 wt. % to 48 wt. % titania; 49 wt. % to 51 wt. % alumina and 51 wt. % to 49 wt. % titania; or 50 wt. % alumina and 50 wt. % titania. An example of the second protective film may include titanium aluminum oxide (TiAlO). Another example of the second protective film is a silica/alumina mixture having greater than 40 wt. % silica, such as greater than 50 wt. % silica, such as greater than 60 wt. % silica, such as greater than 70 wt. % silica, such as greater than 80 wt. % silica, such as in the range of 80 wt. % to 90 wt. % silica and 10 wt. % to 20 wt. % alumina, e.g., 85 wt. % silica and 15 wt. % alumina.

In some non-limiting examples, the protective layer 146 may include an additional third protective film formed over at least a portion of the second protective film. The third protective film may be any of the materials used to form the first and second protective films. The third protective film, for example, may comprise alumina, silica, titania, zirconia, tin oxide, or mixtures thereof. For example, the third protective film may comprise a mixture of silica and alumina. In another example, the third protective film comprises alumina and titania. In another example, the third protective film comprises zirconia.

The protective layer 146 may be the outermost layer of the solar control coating 116. Further, the protective layer 146 can be of non-uniform thickness. By “non-uniform thickness” is meant that the thickness of the protective layer 146 can vary over a given unit area, e.g., the protective layer 146 can have high and low spots or areas. Non-limiting examples of suitable protective layers are described in U.S. Pat. No. 6,869,644; U.S. 2002/0172775; U.S. Pat. Nos. 7,311,961; 6,962,759; and U.S. 2003/0228476.

With continued reference to FIGS. 4-6, the first dielectric layer 132 may have a total thickness in the range of from 35-40 nanometers.

With continued reference to FIGS. 4-6, the first metallic layer 134 may have a total thickness in the range of from 7-9 nanometers.

With continued reference to FIGS. 4-6, the second dielectric layer 136 may have a total thickness in the range of from 70-80 nanometers.

With continued reference to FIGS. 4-6, the second metallic layer 138 may have a total thickness in the range of from 9-11 nanometers.

With continued reference to FIGS. 4-6, the third dielectric layer 140 may have a total thickness in the range of from 65-77 nanometers.

With continued reference to FIGS. 4-6, the third metallic layer 142 may have a total thickness in the range of from 7-9 nanometers.

With continued reference to FIGS. 4-6, the fourth dielectric layer 144 may have a total thickness in the range of from 32-38 nanometers.

With continued reference to FIGS. 4-6, the protective layer 146 may have a total thickness in the range of from 20 nm to 120 nm, preferably 25 nm to 100 nm, more preferably 40 nm to 80 nm, most preferably 50 nm to 70 nm.

With continued reference to FIGS. 4-6, the primer layer 148 may have a total thickness in the range of from 0.5 nm to 5 nm, preferably 1.0 nm to 2.5 nm, more preferably 1.5 nm to 2.5 nm.

With continued reference to FIGS. 4-6, a total combined thickness of the metallic layers (e.g., the first, second, and third metallic layers 134, 138, 142 combined) may range from 10-60 nanometers.

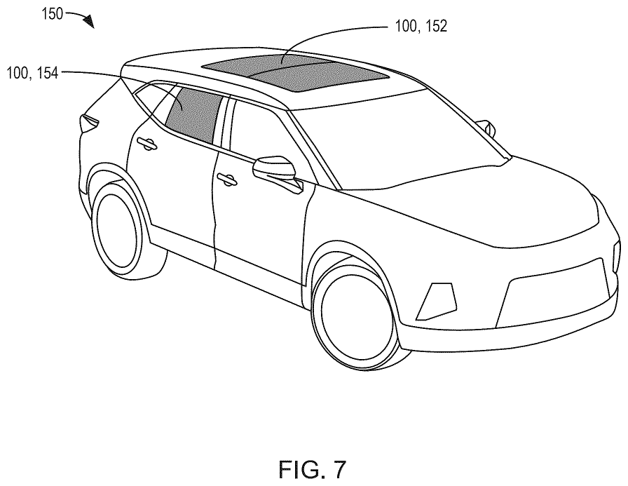

Referring to FIG. 7, a vehicle 150 including the privacy glass 100 is shown according to some aspects of the disclosure. The vehicle 150 may be any sort of vehicle, such as a land, air, space, above water, and/or underwater vehicle. The non-limiting example of the vehicle 150 shown in FIG. 7 is an automobile.

The vehicle 150 may include the privacy glass 100 as any suitable transparency in the vehicle. For example, the vehicle 150 may comprise a sunroof or moonroof 152 containing the privacy glass 100. For example, the vehicle 150 may comprise a passenger window 154 containing the privacy glass 100.

While the privacy glass 100 described herein (e.g. FIG. 7) is shown in the vehicle 150, it will be appreciated that the privacy glass 100 may be included as a component in other types of applications. For example, the privacy glass 100 may be used as an architectural transparency located on a building, such as windows and sky lights.

The present disclosure is also directed to methods of making a privacy glass.

The privacy glass may be made by: providing a first substrate (e.g. the first transparency) wherein the first substrate comprises a No. 1 surface and a No. 2 surface, wherein the first substrate is not privacy glass and where the first substrate comprises a coating on the No. 2 surface; and providing a second substrate (e.g. the second transparency) wherein the second substrate is privacy glass and wherein the second substrate comprises a No. 3 surface and a No. 4 surface. The first substrate and the second substrate may be positioned so that the coating in contact or in proximity to the No. 3 surface of the second substrate. The first substrate and the second substrate may be heated simultaneously to form a heated first substrate and a heated second substrate. The heated first substrate and the heated second substrate may be bent simultaneously. An interlayer may be applied between the first substrate and the second substrate. The first substrate, the interlayer, and the second substrate may be laminated together to form the privacy glass.

The privacy glass may be made by: providing the first substrate wherein the first substrate comprises a No. 1 surface and a No. 2 surface, wherein the first substrate is not privacy glass and wherein the first substrate comprises a coating on the No. 2 surface; and providing a second substrate wherein the second substrate is not privacy glass and wherein the second substrate comprises a No. 3 surface and a No. 4 surface. The first substrate and the second substrate may be positioned so that the coating in contact or in proximity to the No. 3 surface of the second substrate. The first substrate and the second substrate may be heated simultaneously to form a heated first substrate and a heated second substrate. The heated first substrate and the heated second substrate may be bent simultaneously. A tinted interlayer may be applied between the first substrate and the second substrate. The first substrate, the tinted interlayer, and the second substrate may be laminated together to form the privacy glass.

The privacy glass may be made by: providing the first substrate wherein the first substrate comprises a No. 1 surface and a No. 2 surface, wherein the first substrate is not privacy glass and wherein the first substrate comprises a coating on the No. 2 surface; heating the first substrate, bending the first substrate to a curved shape, providing the second substrate wherein the second substrate is privacy glass and wherein the second substrate comprises a No. 3 surface and a No. 4 surface; heating the second substrate, bending the second substrate to be configured to fit within the curved shape of the first substrate; applying an interlayer between the first substrate and the second substrate; and laminating the first substrate, the interlayer, and the second substrate together to form a privacy glass.

The privacy glass may be made by: providing the first substrate wherein the first substrate comprises a No. 1 surface and a No. 2 surface, wherein the first substrate is not privacy glass and wherein the first substrate comprises a coating on the No. 2 surface; heating the first substrate, bending the first substrate to a curved shape, providing the second substrate wherein the second substrate is not privacy glass and wherein the second substrate comprises a No. 3 surface and a No. 4 surface; heating the second substrate, bending the second substrate to be configured to fit within the curved shape of the first substrate; applying a tinted interlayer between the first substrate and the second substrate; and laminating the first substrate, the tinted interlayer, and the second substrate together to form a privacy glass.

The invention is further described in the following numbered clauses:
Clause 1: A privacy glass comprising: a first transparency having a first major surface (No. 1 surface) and an opposing second major surface (No. 2 surface), the No. 1 surface defining an exterior of the privacy glass; a second transparency having a third major surface (No. 3 surface) and an opposing fourth major surface (No. 4 surface), the No. 4 surface defining an interior of the privacy glass; and an interlayer positioned between the No. 2 surface and the No. 3 surface, wherein a solar control coating is arranged over the No. 2 surface, the solar control coating configured to reflect at least 50% of solar infrared radiation, wherein at least one of the interlayer and the second transparency is tinted so that the privacy glass has a visible transmittance of less than 30%, wherein the solar control coating is selected such that the privacy glass has an a* of from −4 to 0.5 and an b* of from −4 to 2.
Clause 2: The privacy glass of clause 1, wherein the interlayer is tinted so as to have a visible transmittance of less than 30%.
Clause 3: The privacy glass of clause 1 or 2, wherein the second transparency is tinted so as to have a visible transmittance of less than 30%.
Clause 4: The privacy glass of any of clauses 1-3, wherein the at least one of the interlayer and the second transparency is tinted by comprising an additive configured to increase visible absorbance of the at least one of the interlayer and the second transparency compared to the at least one of the interlayer and the second transparency without the additive.
Clause 5: The privacy glass of any of clauses 1-4, wherein the at least one of the interlayer and the second transparency is tinted so that the privacy glass has a visible transmittance of less than 5%.
Clause 6: The privacy glass of any of clauses 1-5, wherein the solar control coating is selected such that the privacy glass has an a* of from −2 to 0 and an b* of from −2 to 0.
Clause 7: The privacy glass of any of clauses 1-6, wherein the first transparency has a visible transmittance of greater than 70%.
Clause 8: The privacy glass of any of clauses 1-7, wherein the first transparency comprises ultra clear glass.
Clause 9: The privacy glass of any of clauses 1-8, arranged in a vehicle.
Clause 10: The privacy glass of clause 9, wherein the privacy glass is arranged as a sunroof of the vehicle.
Clause 11: The privacy glass of any of clauses 1-10, wherein the interlayer comprises polyvinyl butyral (PVB).
Clause 12: The privacy glass of any of clauses 1-11, wherein the solar control coating comprises: a first dielectric layer over at least a portion of the No. 2 surface; a first metallic layer over at least a portion of the first dielectric layer; a second dielectric layer over at least a portion of the first metallic layer; a second metallic layer over at least a portion of the second dielectric layer; a third dielectric layer over at least a portion of the second metallic layer; a third metallic layer over at least a portion of the third dielectric layer; and a fourth dielectric layer over at least a portion of the third metallic layer.
Clause 13: The privacy glass of clause 12, wherein a total combined thickness of the metallic layers ranges from 10-60 nanometers.
Clause 14: The privacy glass of clause 12 or 13, wherein at least one of the metallic layers comprises at least one of silver or gold.
Clause 15: The privacy glass of any of clauses 12-14, wherein: the first dielectric layer has a thickness of from 35-40 nanometers; the first metallic layer has a thickness of from 7-9 nanometers; the second dielectric layer has a thickness of from 70-80 nanometers; the second metallic layer has a thickness of from 9-11 nanometers; the third dielectric layer has a thickness of from 65-77 nanometers; the third metallic layer has a thickness of from 7-9 nanometers; and the fourth dielectric layer has a thickness of from 32-38 nanometers.
Clause 16: The privacy glass of any of clauses 12-15, wherein the solar control coating further comprises at least one primer layer over at least one of the metallic layers.
Clause 17: The privacy glass of any of clauses 12-16, wherein the solar control coating further comprises an outermost protective layer over an outermost dielectric layer.
Clause 18: The privacy glass of any of clauses 1-17, wherein the solar control coating is selected such that the privacy glass has an a* of from −4 to 0.5 and an b* of from −4 to 2 at a plurality of angles from 0° to 85°, such as at all angles from 0° to 85° or all angles from 0° to 10°.
Clause 19: A vehicle comprising the privacy glass of any of clauses 1-18.
Clause 20: The vehicle of clause 19, wherein the privacy glass is arranged as a sunroof of the vehicle.
Clause 21: A method of making a privacy glass comprising providing a first substrate wherein the first substrate comprises a No. 1 surface and a No. 2 surface, wherein the first substrate is not privacy glass and wherein the first substrate comprises a coating on the No. 2 surface; providing a second substrate wherein the second substrate is privacy glass and wherein the second substrate comprises a No. 3 surface and a No. 4 surface; positioning the first substrate and the second substrate so that the coating in contact or in proximity to the No. 3 surface of the second substrate; heating the first substrate and the second substrate simultaneously to form a heated first substrate and a heated second substrate; bending the heated first substrate and the heated second substrate simultaneously; applying an interlayer between the first substrate and the second substrate; and laminating the first substrate, the interlayer, and the second substrate together to form a privacy glass.
Clause 22: A method of making a privacy glass comprising providing a first substrate wherein the first substrate comprises a No. 1 surface and a No. 2 surface, wherein the first substrate is not privacy glass and wherein the first substrate comprises a coating on the No. 2 surface; providing a second substrate wherein the second substrate is not privacy glass and wherein the second substrate comprises a No. 3 surface and a No. 4 surface; positioning the first substrate and the second substrate so that the coating in contact or in proximity to the No. 3 surface of the second substrate; heating the first substrate and the second substrate simultaneously to form a heated first substrate and a heated second substrate; bending the heated first substrate and the heated second substrate simultaneously; applying a tinted interlayer between the first substrate and the second substrate; and laminating the first substrate, the tinted interlayer and the second substrate together to form a privacy glass.
Clause 23: A method of making a privacy glass comprising providing a first substrate wherein the first substrate comprises a No. 1 surface and a No. 2 surface, wherein the first substrate is not privacy glass and wherein the first substrate comprises a coating on the No. 2 surface; heating the first substrate, bending the first substrate to a curved shape, providing a second substrate wherein the second substrate is privacy glass and wherein the second substrate comprises a No. 3 surface and a No. 4 surface; heating the second substrate, bending the second substrate to be configured to fit within the curved shape of the first substrate; applying an interlayer between the first substrate and the second substrate; and laminating the first substrate, the interlayer, and the second substrate together to form a privacy glass.
Clause 24: A method of making a privacy glass comprising providing a first substrate wherein the first substrate comprises a No. 1 surface and a No. 2 surface, wherein the first substrate is not privacy glass and wherein the first substrate comprises a coating on the No. 2 surface; heating the first substrate, bending the first substrate to a curved shape, providing a second substrate wherein the second substrate is not privacy glass and wherein the second substrate comprises a No. 3 surface and a No. 4 surface; heating the second substrate, bending the second substrate to be configured to fit within the curved shape of the first substrate; applying a tinted interlayer between the first substrate and the second substrate; and laminating the first substrate, the tinted interlayer and the second substrate together to form a privacy glass.
Clause 25: The method of any of clauses 21-24, wherein the solar control coating is selected such that the privacy glass has an a* of from −2 to 0 and an b* of from −2 to 0.
Clause 26: The method of any of clauses 21-25, wherein the solar control coating comprises: a first dielectric layer over at least a portion of the No. 2 surface; a first metallic layer over at least a portion of the first dielectric layer; a second dielectric layer over at least a portion of the first metallic layer; a second metallic layer over at least a portion of the second dielectric layer; a third dielectric layer over at least a portion of the second metallic layer; a third metallic layer over at least a portion of the third dielectric layer; and a fourth dielectric layer over at least a portion of the third metallic layer.
Clause 27: The method of clause 26, wherein a total combined thickness of the metallic layers ranges from 10-60 nanometers.
Clause 28: The method of clause 26 or 27, wherein at least one of the metallic layers comprises at least one of silver or gold.
Clause 29: The method of any of clauses 26-28, wherein: the first dielectric layer has a thickness of from 35-40 nanometers; the first metallic layer has a thickness of from 7-9 nanometers; the second dielectric layer has a thickness of from 70-80 nanometers; the second metallic layer has a thickness of from 9-11 nanometers; the third dielectric layer has a thickness of from 65-77 nanometers; the third metallic layer has a thickness of from 7-9 nanometers; and the fourth dielectric layer has a thickness of from 32-38 nanometers.
Clause 30: The method of any of clauses 26-29, wherein the solar control coating further comprises at least one primer layer over at least one of the metallic layers.
Clause 31: The method of any of clauses 26-30, wherein the solar control coating further comprises an outermost protective layer over an outermost dielectric layer.

### EXAMPLES

The following Examples illustrate various embodiments of the invention. However, it is to be understood that the invention is not limited to these specific embodiments.

### Example 1

### Privacy Glass

A privacy glass was formed according to the present disclosure having the following sequence of layers, from bottom to top. The multi-layer coating was applied to the No. 2 surface of the first transparency.

Example 1

| Layer: | Thickness (nm) | Label |
|---|---|---|
| Clear Glass | 2.1 mm | First Transparency |
| ZnSn oxide | 22.71 | First Dielectric Layer |
| Zn90 oxide | 14.81 | |
| Ag heated | 8.02 | First Metallic Layer |
| TiOx heated | 3.87 | First Primer Layer |
| Zn90 oxide | 10.01 | Second Dielectric Layer |
| ZnSn oxide | 54.59 | |
| Zn90 oxide | 10.20 | |
| Ag heated | 9.78 | Second Metallic Layer |
| TiOx heated | 2.48 | Second Primer Layer |
| Zn90 oxide | 9.72 | Third Dielectric Layer |
| ZnSn oxide | 52.04 | |
| Zn90 oxide | 10.17 | |
| Ag heated | 8.05 | Third Metallic Layer |
| TiOx heated | 2.79 | Third Primer Layer |
| Zn90 oxide | 9.85 | Fourth Dielectric Layer |
| ZnSn oxide | 25.42 | |
| Si85Al15 | 60.0 | Protective Layer |
| Tinted Vinyl | 0.7 mm | Interlayer |
| Interlayer | | |
| Clear Glass | 1.6 mm | Second Transparency |

The privacy glass formed according to Example 1 had the following glass-side neutral aesthetic properties.

Example 1

| | |
|---|---|
| L* | 26.39 |
| a* | −0.64 |
| b* | −1.48 |

### Examples 2-6

### Prophetic Privacy Glasses

The following privacy glass arrangements having the following sequence of layers, from bottom to top, are also within the scope of the present disclosure. The coating referred to in the following prophetic examples refers to the multi-layer coating from Example 1 (first dielectric layer to protective layer).

| Example 2 | Example 3 | Example 4 | Example 5 | Example 6 |
|---|---|---|---|---|
| Clear Glass | Ultra Clear | Ultra Clear | Clear Glass | Ultra Clear |
| | Glass | Glass | | Glass |
| Coating | Coating | Coating | Coating | Coating |
| Clear Vinyl | Clear Vinyl | Tinted Vinyl | Tinted Vinyl | Tinted Vinyl |
| Interlayer | Interlayer | Interlayer | Interlayer | Interlayer |
| Tinted Glass | Tinted Glass | Clear Glass | Tinted Glass | — |

Prophetic Examples 2-6 are expected to have similar glass-side L*, a*, and b* values compared to Example 1, with expected shifts in a* values being less than 1.5, such as less than 1 unit, or less than 0.5 units and with expected shifts in b* values being less than 0.5.

It will be readily appreciated by those skilled in the art that modifications may be made to the invention without departing from the concepts disclosed in the foregoing description. Accordingly, the particular embodiments described in detail herein are illustrative only and are not limiting to the scope of the invention, which is to be given the full breadth of the appended claims and any and all equivalents thereof.

What is claimed is:

1. A privacy glass comprising:
a first transparency having a first major surface (No. 1 surface) and an opposing second major surface (No. 2 surface), the No. 1 surface defining an exterior of the privacy glass;
a second transparency having a third major surface (No. 3 surface) and an opposing fourth major surface (No. 4 surface), the No. 4 surface defining an interior of the privacy glass; and
an interlayer positioned between the No. 2 surface and the No. 3 surface,
wherein a solar control coating is arranged over the No. 2 surface, the solar control coating configured to reflect at least 50% of solar infrared radiation,
wherein at least one of the interlayer and the second transparency is tinted so that the privacy glass has a visible transmittance of less than 30%,
wherein the solar control coating is selected such that the privacy glass has an a* of from −4 to 0.5 and an b* of from −4 to 2.

2. The privacy glass of claim 1, wherein the interlayer is tinted so as to have a visible transmittance of less than 30%.

3. The privacy glass of claim 1, wherein the second transparency is tinted so as to have a visible transmittance of less than 30%.

4. The privacy glass of claim 1, wherein the at least one of the interlayer and the second transparency is tinted by comprising an additive configured to increase visible absorbance of the at least one of the interlayer and the second transparency compared to the at least one of the interlayer and the second transparency without the additive.

5. The privacy glass of claim 1, wherein the at least one of the interlayer and the second transparency is tinted so that the privacy glass has a visible transmittance of less than 5%.

6. The privacy glass of claim 1, wherein the solar control coating is selected such that the privacy glass has an a* of from −2 to 0 and an b* of from −2 to 0.

7. The privacy glass of claim 1, wherein the first transparency has a visible transmittance of greater than 70%.

8. The privacy glass of claim 1, wherein the first transparency comprises ultra clear glass.

9. The privacy glass of claim 1, arranged in a vehicle.

10. The privacy glass of claim 9, wherein the privacy glass is arranged as a sunroof of the vehicle.

11. The privacy glass of claim 1, wherein the interlayer comprises polyvinyl butyral (PVB).

12. The privacy glass of claim 1, wherein the solar control coating comprises:
a first dielectric layer over at least a portion of the No. 2 surface;
a first metallic layer over at least a portion of the first dielectric layer;
a second dielectric layer over at least a portion of the first metallic layer;
a second metallic layer over at least a portion of the second dielectric layer;
a third dielectric layer over at least a portion of the second metallic layer;
a third metallic layer over at least a portion of the third dielectric layer; and
a fourth dielectric layer over at least a portion of the third metallic layer.

13. The privacy glass of claim 12, wherein a total combined thickness of the metallic layers ranges from 10-60 nanometers.

14. The privacy glass of claim 12, wherein at least one of the metallic layers comprises at least one of silver or gold.

15. The privacy glass of claim 12, wherein:
the first dielectric layer has a thickness of from 35-40 nanometers;
the first metallic layer has a thickness of from 7-9 nanometers;
the second dielectric layer has a thickness of from 70-80 nanometers;
the second metallic layer has a thickness of from 9-11 nanometers;
the third dielectric layer has a thickness of from 65-77 nanometers;
the third metallic layer has a thickness of from 7-9 nanometers; and
the fourth dielectric layer has a thickness of from 32-38 nanometers.

16. The privacy glass of claim 12, wherein the solar control coating further comprises at least one primer layer over at least one of the metallic layers.

17. The privacy glass of claim 12, wherein the solar control coating further comprises an outermost protective layer over an outermost dielectric layer.

18. The privacy glass of claim 1, wherein the solar control coating is selected such that the privacy glass has an a* of from −4 to 0.5 and an b* of from −4 to 2 at a plurality of angles from 0° to 85°, such as at all angles from 0° to 85° or at all angles from 0° to 10°.

19. A vehicle comprising the privacy glass of claim 1.

20. The vehicle of claim 19, wherein the privacy glass is arranged as a sunroof of the vehicle.
